(19) United States
(12) Patent Application Publication
(10) Pub. No.: US 2025/0278619 A1
(43) Pub. Date: Sep. 4, 2025

(54) Neuromorphic-Ternary Hybrid Architecture for Energy-Efficient AI Processing

(71) Applicant: LARRY LIM KHENG CHEONG, SINGAPORE (SG)

(72) Inventor: LARRY LIM KHENG CHEONG, SINGAPORE (SG)

(21) Appl. No.: 19/204,486

(22) Filed: May 10, 2025

(51) Int. Cl. G06N 3/063

(52) U.S. Cl. CPC G06N 3/063

(57) ABSTRACT

This invention describes a novel hybrid AI processor architecture that merges neuromorphic spiking neural networks with ternary logic computation units. While most neuromorphic chips simulate neuron spiking behavior using binary thresholds and event-driven activation, this invention replaces conventional binary synapses with ternary-weighted interconnections, enabling logic states of −1, 0, and +1.

The ternary logic processing units perform low-precision, high-parallelism matrix operations that more closely reflect biological excitation and inhibition patterns, while minimizing silicon area and energy consumption. The architecture enables continuous, adaptive information propagation using ternary-weighted activation, improving both inference and on-device learning performance.

This system is especially well-suited for real-time AI on edge devices, robotics, and adaptive embedded systems. It may be implemented using standard CMOS, ferroelectric memory, or memristive synapse arrays.

### STATEMENT UNDER 37 CFR § 1.125(b)

The substitute specification submitted on May 19, 2025 contains no new matter relative to the originally filed specification of May 10, 2025.

### FIELD OF THE INVENTION

The present invention relates to artificial intelligence (AI) processor architecture. More specifically, it pertains to the design of neuromorphic hardware systems that incorporate ternary logic elements, enabling low-power, adaptive AI computation through a hybridized spiking and symbolic architecture.

### BACKGROUND OF THE INVENTION

AI accelerators are increasingly required to handle tasks that involve both high-speed numeric computation and energy-efficient pattern recognition. Traditional binary logic circuits and GPUs are highly optimized for matrix operations, but lack the dynamic learning and temporal adaptability of biological neural networks.

Neuromorphic processors attempt to emulate aspects of the brain by encoding information through spikes and using event-driven synaptic updates. However, current neuromorphic hardware is constrained by limitations in weight precision, memory density, and efficient implementation of both excitatory and inhibitory behavior.

Simultaneously, ternary logic systems-based on three discrete states: 1 (inhibitory), 0 (null), and +1 (excitatory)—have emerged as promising alternatives to binary architectures. They reduce switching complexity, support simplified matrix algebra, and map more naturally to biological signaling. Yet, existing ternary chips lack temporal modeling and fail to capture the sparse, time-dependent information flow critical in perception and feedback tasks.

There exists a need for an architecture that combines the state efficiency of ternary logic with the dynamic signaling of neuromorphic designs.

### SUMMARY OF THE INVENTION

The present invention introduces a hybrid brain-inspired processor architecture that combines ternary logic cores with a neuromorphic spiking control layer.

The system includes:
A ternary logic neuron core that supports computation with 1, 0, and +1 weights;
A ternary-to-spike encoder that converts ternary matrix outputs into spike-based signals;
A weighted synapse matrix utilizing ternary states and programmable thresholds;
An asynchronous spike scheduler for sparse temporal signal propagation.

This architecture enables low-power, high-parallelism AI inference and learning, with enhanced biological fidelity and hardware efficiency. It can be fabricated using CMOS, ferroelectric RAM, or resistive memory arrays, enabling deployment on mobile, embedded, or edge devices.

An overview of the architecture is illustrated in FIG. 1.

### BRIEF DESCRIPTION OF THE DRAWINGS

FIG. 1 illustrates a high-level overview of the hybrid brain-inspired AI processor that integrates ternary logic computation with spiking neuron signal flow.

FIG. 2 depicts the ternary logic neuron core and its output to ternary-valued neurons.

FIG. 3 shows the ternary-to-spike encoder converting ternary outputs into asynchronous spike signals.

### DETAILED DESCRIPTION OF THE INVENTION

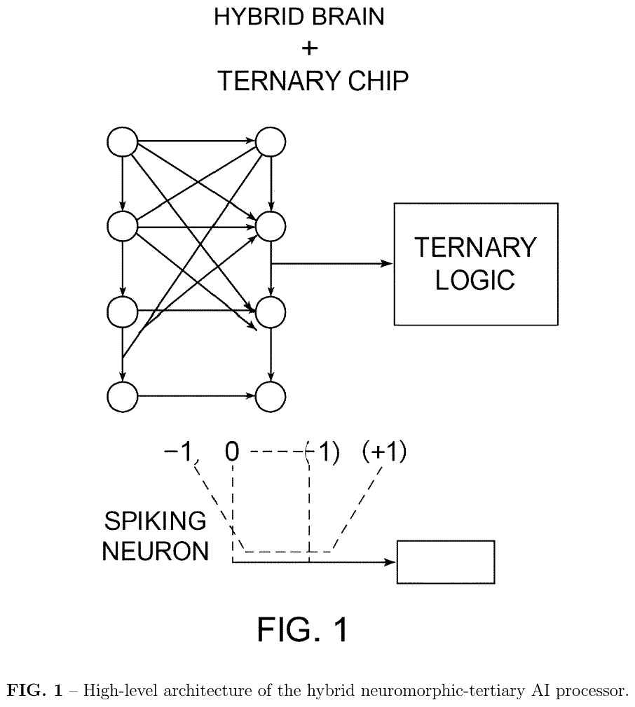

The invention is further illustrated by the following components, shown in FIGS. 1 to 3.

### Ternary Neuron Core

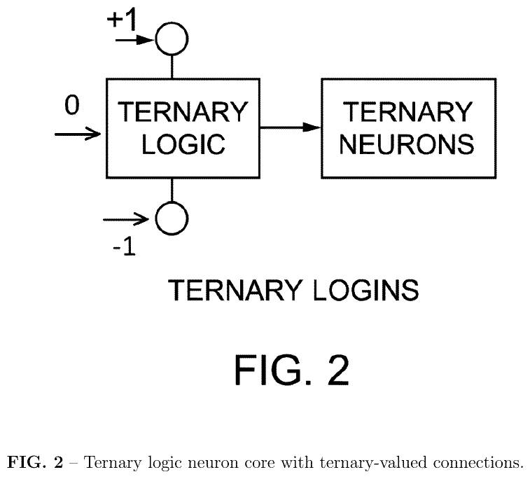

FIG. 2 illustrates the core computation unit consisting of a ternary-weighted matrix multiplier capable of processing input activations. Each synaptic connection is encoded as one of three values: 1 (inhibitory), 0 (null), or +1 (excitatory). Matrix operations are performed using sign-magnitude encoding, enabling low-power hardware circuits and reduction in transistor count.

### Ternary-to-Spike Encoder

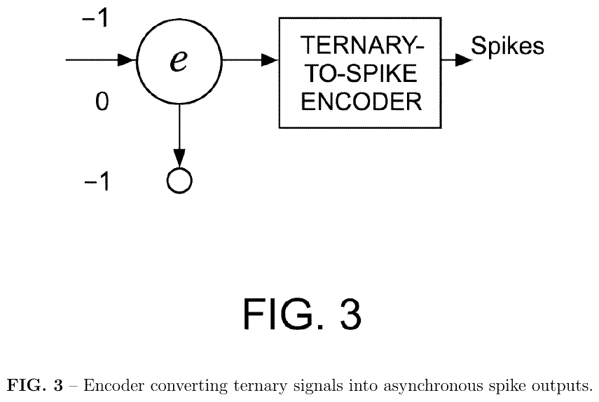

As shown in FIG. 3, outputs from the ternary logic core are fed into an encoder circuit which maps non-zero outputs into spike events. These spikes are timestamped and propagated asynchronously through a temporal bus. The mapping may be linear or exponential depending on the desired temporal coding scheme (e.g., rate-based or latency-based).

### Weighted Ternary Synapse Matrix

Each spiking neuron connects to downstream units via a ternary-weighted matrix. Synaptic weights are stored in non-volatile memory, allowing on-device learning or adaptation. Spike timing and strength modulate synaptic updates during training or Hebbian-like adaptation.

### Spike Scheduler and Propagation Layer

An asynchronous scheduler handles spike queueing and delivery to downstream layers. It uses event buffers to allow multiple spikes to be processed in parallel without requiring a centralized clock, reducing energy and latency. The scheduler includes programmable delay paths and stochastic gates, mimicking biological uncertainty in signal transmission.

### Applications and Integration

This architecture is ideal for:
Edge AI (smart cameras, drones, IoT inference);
Robotics (adaptive motion, sensory feedback);
Brain-computer interfaces;
Sensor fusion systems (audio-visual, haptics, etc.).

The system can be implemented as a standalone chip, a co-processor for conventional AI accelerators, or an embedded module in neuromorphic SoCs.

1. A hybrid AI processor architecture, comprising:
(a) a ternary logic neuron core configured to perform matrix operations using logic values −1, 0, and +1;
(b) a ternary-to-spike encoder configured to map ternary outputs into asynchronous spike signals;
(c) a ternary-weighted synapse matrix storing non-volatile weights for spike-based propagation;
(d) a spike scheduler configured to manage asynchronous signal propagation to downstream processing layers.

2. The system of claim 1, wherein the ternary logic neuron core performs matrix multiplications using sign-magnitude encoding logic circuits.

3. The system of claim 1, wherein the ternary-to-spike encoder is configured to generate spikes based on rate coding or latency coding rules.

4. The system of claim 1, wherein the ternary-weighted synapse matrix comprises programmable memory elements selected from the group consisting of: static RAM (SRAM), ferroelectric RAM (FeRAM), resistive RAM (RRAM), or memristor arrays.

5. The system of claim 1, wherein the spike scheduler comprises an event-driven queue with programmable delay paths and parallel delivery lanes.

6. The system of claim 1, wherein the processor further comprises a spike bus connecting multiple hybrid cores, enabling modular scalability across neural networks.

7. The system of claim 1, wherein the hybrid AI processor is fabricated as a monolithic silicon chip or a chiplet for multi-die packaging.

8. The system of claim 1, wherein the hybrid architecture is implemented in an edge AI device, a robot control module, or a neuromorphic sensor platform.

9. The system of claim 1, wherein spike events are encoded using voltage thresholds or time-delay gates to simulate biological uncertainty.

10. The system of claim 1, wherein the hybrid system enables in-place learning by updating ternary synapse weights based on spike timing-dependent plasticity (STDP) or Hebbian rules.
